(19) United States
(12) Patent Application Publication
(10) Pub. No.: US 2017/0044027 A1
(43) Pub. Date: Feb. 16, 2017

(54) Fluid Treatment System

(71) Applicant: WALLENIUS WATER AB, Stockholm (SE)

(72) Inventors: Ulf ARBÉUS, Lidingö (SE); Henrik LAGERSTEDT, Stockholm (SE); Staffan STRAND, Stockholm (SE); Haidong LIAO, Bandhagen (SE)

(73) Assignee: WALLENIUS WATER AB, Stockholm (SE)

(21) Appl. No.: 15/306,856

(22) PCT Filed: Apr. 28, 2015
(86) PCT No.: PCT/SE2015/050475

§ 371 Date: Oct. 26, 2016

(30) Foreign Application Priority Data
May 2, 2014 (SE) 1450522-6

(51) Int. Cl. C02F 1/32

(52) U.S. Cl. CPC C02F 1/325; C02F 2303/22

(57) ABSTRACT

A fluid treatment system (2) for treating a fluid (4), the system (2) comprises: —a translucent sleeve (6) surrounding at least one light source (8) and mounted within a cell (10) of the system (2); —a housing (12) configured to receive the sleeve (6) therein, a hollow cavity (18) is defined between an outer surface (14) of the sleeve (6) and an inner surface (16) of the housing (12) defining a cavity for flowing the fluid (4) therein. The system (2) further comprises: —a fluid flowing device (22) to flow said fluid (4) through the hollow cavity (18) at a velocity of 3 m/s or higher such that the velocity of the fluid in relation to the outer surface (14) prevents fouling and/or scaling from aggregating on the outer surface (14) of the sleeve (6), —a recirculation assembly (24) configured to recirculate said fluid (4) through said hollow cavity (18). In addition a method is provided for treatment of a fluid in the fluid treatment system.

### FIELD OF THE INVENTION

The present invention relates to a fluid treatment system and a method in a fluid treatment system, according to the preambles of the independent claims.

### BACKGROUND OF THE INVENTION

There are many applications where UV light sources are used for treating liquids. The applicant of the present application, Wallenius Water AB in Sweden, has developed and is selling water treatment equipment having a water purifier comprising an elongated tubular treatment chamber with an inlet and an outlet. In the center of the treatment chamber a generally tubular quartz glass is arranged and inside the quartz glass a UV source, such as a lamp capable of generating wavelengths in the UV region. The inner surface of the treatment chamber may be covered with catalytic material, such as titanium dioxide, which catalysts promotes and increases the amount of treatment material.

Another type of treatment reactor developed by the applicant also comprises a treatment chamber having oppositely arranged in- and outlets, where the UV light sources are arranged in elongated quartz glass tubes. These tubes are arranged perpendicular to the flow of liquid to be treated through the treatment chamber.

The above described treatment units are functioning very well for treating all sorts of liquids and in particular water, where the latter described treatment unit is specially adapted for treatment of ballast water in ships. The liquid that is treated often comprises particles and other solid matter other than the organisms that are killed off by the treatment units. These particles, as well as other residue from the killed off organisms, have a tendency to stick on the interior surfaces of treatment units. These particles, and other residue, aggregated on the surface are generally denoted as foulings. UV light treatment, more specifically UV-light in combination with heat, sometimes provokes chemical reactions resulting in depositions on the interior surfaces. These resulting depositions are generelly denoted as scalings.

Often scalings are more difficult to remove from the surface than foulings.

This means that in order to have an optimum efficiency of the treatment device the interior has to be cleaned regularly. According to one conventionally used solution cleaning is performed by injecting cleaning liquids into the treatment chamber, where the cleaning liquids are developed for removing the foulings or scalings on the surfaces. However, even if they are efficient for removing fouling/scaling and the like deposits on the surfaces of the treatment chambers, they require that the treatment units are closed down during a period of time, whereby thus no treatment of liquid may be performed.

According to other suggestions, various forms of wiper mechanisms have been designed to remove fouling/scaling from surfaces. All such forms of wiper mechanisms act to ‘wipe off’ the layer from the external surface of the sleeve. Unfortunately, such wiper mechanisms suffer from a number of drawbacks, including the fact that they are typically large complicated devices that require a large annular space between the outside surface of the sleeve housing the UV lamp and the surrounding tubing housing the sleeve in order to accommodate the wiper mechanism. The treatment system relies on the transmittance of the fluid in order to allow the UV photons to reach the contaminants in the fluid passing through the annular region between the sleeve and housing. However, as the size of the annular region between the sleeve and tubing surrounding the sleeve increases, the effectiveness of the UV light at the outer edges of the annulus region decreases, which often impacts the efficiency of the system. In addition, conventional wiper mechanisms contain a number of moving parts that are submersed in the fluid, thus raising reliability concerns. Also, such wiping mechanisms can etch the surface of the quartz sleeve during the wiping action, which may result in premature failure of the sleeve. Furthermore, some wiper mechanisms employ acidic solutions in the cleaning process, thus raising corrosion issues.

In WO-2009/067080 is disclosed a device for a liquid treatment unit, which unit comprises UV generating means, arranged inside a compartment, which compartment is arranged in a liquid treatment enclosure. The enclosure is provided with an inlet and an outlet, and the compartment comprises UV light permeable material. The liquid to be treated surrounds the compartment, and a mechanical cleaning means is arranged and capable of cleaning the outer surface of the compartment when the unit is in operation.

U.S. Pat. No. 5,625,194 relates to an apparatus for continuous cleaning of tubular lamp wells for UV-light producing lamps. A large number of small plastic pellets are dispersed in the reaction solution and maintained in turbulent motion by a stirrer in the reactor. The pellets frequently impact the outer surface of the tubular wells with sufficient momentum to prevent deposits of material from adhering on the tubular wells.

U.S. Pat. No. 7,425,272 relates to a system for cleaning protective sleeves in UV decontamination systems. The disclosed system for cleaning the outer surface of a quartz sleeve is based on the recognition that providing a honing material with a predetermined abrasiveness through the annulus at high velocity works to remove aggregated particles from the outer surface. As a result, the disclosed system provides for the increasing of the flow rate (velocity) of the fluid passing through the annulus when a honing material is added to the fluid, so as to abrasively contact the outer surface of the sleeve in order to remove aggregated contaminants and other particles.

In U.S. Pat. No. 7,425,272 the linear velocity of a slurry material passing through the annulus during a cleaning process is about 1 m/s, and in one particular example it is stated that the velocity is at least 0.5 m/s.

U.S. Pat. No. 5,124,131 relates to a compact high-throughput ultraviolet processing chamber. In the processing chamber an array of protective lamp shells including UV-lamps is arranged. The lamp shells have a generatlly cylindrical form extending transversely through the centraol region of the flow passageway in the processing chamber.

In U.S. Pat. No. 5,626,768 an apparatus for killing bacteria within an opaque liquid is disclosed. The opaque liquid is moved along a high power ultraviolet radiation surface at a velocity which causes turbulent flow in the liquid. The turbulent flow mixes the opaque liquid so that all the liquid is exposed to the radiation even though the radiation does not penetrate the liquid to any significant depth.

Thus, as discussed above many different solutions exist for removing fouling and/or scaling adhered to, or preventing fouling/scaling to adhere to, surfaces of a reactor, e.g. the lamp glass and the heat exchangers.

However, there is still need for improvements in order to minimize manual work during the cleaning procedure, to minimize or eliminate service period time, and to perform cleaning procedures taken environmental aspects into account. An overall requirement is also to achieve a procedure that is less expensive than the presently used methods. Thus, the object of the present invention is to achieve an improved fluid treatment system that removes, or at least mitigates, one or many of the drawbacks listed above.

### SUMMARY OF THE INVENTION

The above-mentioned object is achieved by the present invention according to the independent claims.

Preferred embodiments are set forth in the dependent claims.

According to one aspect a fluid treatment system is provided for treating a fluid. The system comprises a translucent sleeve surrounding at least one light source and mounted within a cell of the system and a housing configured to receive the sleeve therein, a hollow cavity is defined between an outer surface of the sleeve and an inner surface of the housing defining a cavity for flowing the fluid therein. Furthermore, the system comprises a fluid flowing device configured to flow said fluid through the hollow cavity at a velocity such that the velocity of the fluid in relation to the outer surface prevents fouling and/or scaling from aggregating on the outer surface of the sleeve, and a recirculation assembly configured to recirculate said fluid through said hollow cavity.

According to another aspect a method for treating a fluid in a fluid treatment system is provided. The fluid treatment system comprises a translucent sleeve surrounding at least one light source and mounted within a cell of the system and a housing configured to receive the sleeve therein, a hollow cavity is defined between an outer surface of the sleeve and an inner surface of the housing defining a cavity for flowing the fluid therein. The method comprises the steps of:
flowing the fluid into the cell by a fluid flowing device, through the hollow cavity at a velocity such that the velocity of the fluid in relation to the outer surface prevents fouling and/or scaling from aggregating on the outer surface of the sleeve;
recirculating said fluid through said hollow cavity by a recirculation assembly.

The velocity is defined as flow rate (volume per time) divided by the cross-sectional area in the cell.

It has been a general belief that in order to achieve an acceptable UV-dose the velocity must not be too high; used velocities are normally approximately 1 meter/second or lower. By, as suggested in accordance with the present invention, increasing the velocity to a higher velocity, e.g. 3 m/s or higher, and allowing the fluid to pass the reactor numerous times, the same or even an increased effect by the UV-illumination may be achieved. In addition, the increased velocity will prevent or at least reduce the growth of fouling and/or scaling on critical surfaces, e.g. on UV-lamps.

Tests have shown that the higher velocity has proven particularly efficient for preventing aggregation of scalings on critical surfaces.

Recirculation of fluid is a presumption for a high-velocity system. A high-velocity system will work effectively in a recirculating system, even though the dose level at every passage through the reactor is relatively low due to the short residence time.

The inventors have found that when the velocity is increased, e.g. from 1 to e.g. 3 m/s or higher, advantageous effects of the fouling and/or scaling at the lamp surface have been identified, i.e. less fouling/scaling is identified. This in turn results in lower cost because cleaning of the lamp surface may be obviated or even unnecessary.

In one important application the fluid treatment system is used in connection with cleaning of so-called metal working fluids (also called coolants).

The working fluids often includes minor abrasive particles and one benefit of the present invention is to use the abrasive nature of the working fluids.

Thus, the present invention is advantageous in many aspects, e.g. the system does not have to be stopped for service, i.e. higher efficiency and lower service costs; no cleaning material has to be added or used, i.e. more friendly to the environment, and the system is less complex than known systems where e.g. mechanical wipers must be arranged.

### SHORT DESCRIPTION OF THE APPENDED DRAWINGS

FIG. 1 is a schematic illustration of a fluid treatment system according to the present invention.

FIG. 2 is a cross-sectional view of a cell according to one embodiment of the system.

FIG. 3 is a flow-diagram illustrating the method according to the present invention.

### DETAILED DESCRIPTION OF PREFERRED EMBODIMENTS OF THE INVENTION

Throughout the detailed description and figures the same reference signs are used to denote the same or similar items.

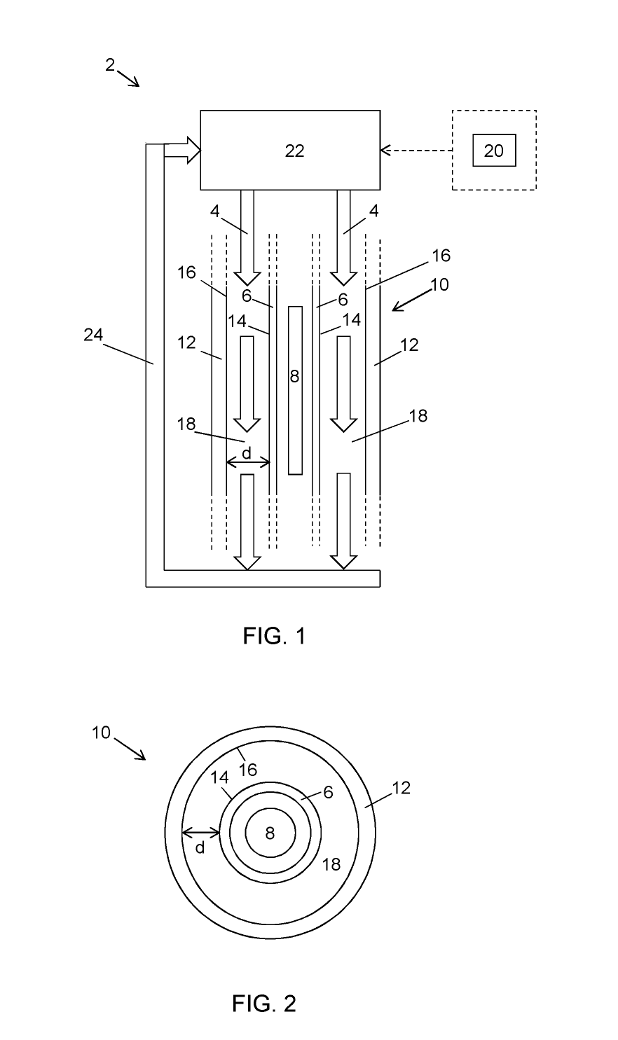

First it is referred to FIG. 1 which schematically illustrates a fluid treatment system according to the present invention.

As discussed in the background section the fluid treatment system may be applied for treating various fluids. The fluid is preferably an opaque fluid, e.g. an edible liquid or a metal working fluid. In addition the fluid may be ballast water.

The present invention relates to a fluid treatment system 2 for treating a fluid 4. The system 2 comprises a translucent sleeve 6 surrounding at least one light source 8, e.g. an ultraviolet (UV) light source, and mounted within a cell 10 of the system 2, and a housing 12 configured to receive the sleeve 6 therein. A hollow cavity 18 is defined between an outer surface 14 of the sleeve 6 and an inner surface 16 of the housing 12 defining a cavity for flowing the fluid 4 therein.

The system 2 further comprises a fluid flowing device 22 configured to flow the fluid 4 through the hollow cavity 18 at a velocity of 3 meter per second or more such that the velocity of the fluid in relation to the outer surface 14 prevents fouling and/or scaling from aggregating on the outer surface 14 of the sleeve 6.

The fluid flowing device 22 may be manually activated, e.g. by simply pressing a start button, or activated by an optional control unit 20 which is indicated by dashed lines in the figure.

In particular the present invention has proven advantageous when applied on metal working fluid which includes minor abrasive particles whose abrasive nature improves the prevention of aggregation of fouling or scaling on the outer surface of the sleeve.

The system 2 is further provided with a recirculation assembly 24 configured to recirculate the fluid 4 through said hollow cavity 18. The reason for recirculating the fluid has been briefly discussed above, and is related to the increased velocity which results in less radiation dose per passage. Thereby numerous passages are required to achieve the required treatment of the fluid.

In particular the fluid flowing device 22 is configured to continuously flow the fluid into the cell 10, through the hollow cavity 18 at a velocity, and out of the cell 10.

According to one embodiment the fluid flowing device 22 is a pump arranged e.g. in a connection inlet tube supplying the treatment system with the fluid. The used pump may be any pump applicable of generating a fluid flow, e.g. displacement pumps, impulse pumps, centrifugal pumps, etc.

In FIG. 1 an optional control unit 20 (dashed lines) is included.

The control unit may be a computer provided with a control computer program where relevant input data easily is input via a terminal or a touchscreen. As an alternative the control unit is a dedicated unit with relevant processing capabilities to store and run control program.

In practise the control is performed by generating an electrical control signal including control values, and by applying the control signal to the fluid flowing device, e.g. the pump, that is controlled accordingly.

Thus, the fluid flowing device 22 is configured to flow the fluid at a velocity of 3 meter per second or more. One important aspect of the present invention is that the velocity continuously is higher than a lower velocity limit, e.g. 3 m/s.

Tests have proven that the desired effect of reducing the aggregation of fouling/scaling may be identified even below fluid velocities of 3 m/s, but the effect improves as the velocity increases. In some tests velocities around 4.5 m/s have proven excellent results.

According to one embodiment the fluid flowing device 22 is configured to flow the fluid at a varying velocity. The velocity may then be varied between a low velocity limit, e.g. in the range of 3-5 m/s, and a high velocity limit, e.g. in the range of 6-8 m/s. This feature may be applicable in specific conditions that require higher cleaning capabilities.

In one further refinement the control unit 20 is configured to control the fluid flowing device 22 to flow the fluid according to a predetermined velocity regimen. The velocity regimen may include control instructions for varying the velocity between a low velocity limit and a high velocity limit. The variation may be proportional, i.e. being a saw-tooth shaped curve, or be like a sinus-curve.

The low velocity limit may be in the range of 3-5 m/s and the high velocity limit may be in the range of 6-8 m/s, or a predetermined portion higher than the low veloctiy limit, e.g. in the interval of 50%-100% higher than the low velocity limit. The velocity may be varied by a frequency of 1-5 Hz.

In another embodiment the control unit 20 is configured to control the fluid flowing device 22 to flow the fluid according to another predetermined velocity regimen, which velocity regimen includes control instructions for repetitively temporarily increasing the velocity from a normal velocity to a predetermined high velocity. Preferably, the normal velocity is in the range of 3-5 m/s, and the high velocity may be in the range of 6-8 m/s, or a predetermined portion higher than the normal velocity, e.g. in the interval of 50%-100% higher than the normal velocity. The change of velocity may be performed by a frequency of 0.5-5 Hz.

In one embodiment the defined hollow cavity 18 is an annulus, i.e. the sleeve 6 and the housing 12 have essentially circular cross-sections. A cross-sectional view of this embodiment is illustrated by FIG. 2. In the figure is indicated a distance d between the outer surface 14 of the sleeve 6 and the inner surface 16 of the housing 12. The distance d may be in the range of 3-40 mm and is naturally dependent upon the actual use of the system.

However, the invention is equally applicable on cells including sleeves and/or housings having other cross-sectional shapes, e.g. rectangular or elliptical.

The recirculation assembly 24 is preferably a closed recirculation assembly. In FIG. 1 the recirculation assembly is only schematically illustrated. The assembly may comprise one or many tubes, tube connections, one or many fluid flowing devices, e.g. pumps, for flowing the liquid from the outlet of a cell 10 to the inlet of the cell. The recirculation assembly may include a tank that the fluid passes in its way from the outlet to the inlet. This tank may in its turn be connected to a larger fluid tank, e.g. a ballast tank, or a container for metal working liquid. The connection between the larger tank and the treatment system tank must ensure a desired and required fluid exchange between the tanks. In one embodiment the entire, or parts of, the fluid treatment system may be submerged into a tank, e.g. a ballast tank or a metal working fluid tank.

The liquid treatment system may naturally include numerous cells, e.g. arranged in parallel in a cell module.

The invention further comprises a method for treating a fluid in a fluid treatment system of the kind described above in with references to FIGS. 1 and 2. Thus, the system comprises a translucent sleeve surrounding at least one light source, e.g. a UV light source, and mounted within a cell of the system, and a housing configured to receive the sleeve therein, a hollow cavity is defined between an outer surface of the sleeve and an inner surface of the housing defining a cavity for flowing the fluid therein.

In particular the method is applicable for treating an opaque fluid, which may be an edible liquid or a metal working fluid. The method may also be used in relation of treating ballast water.

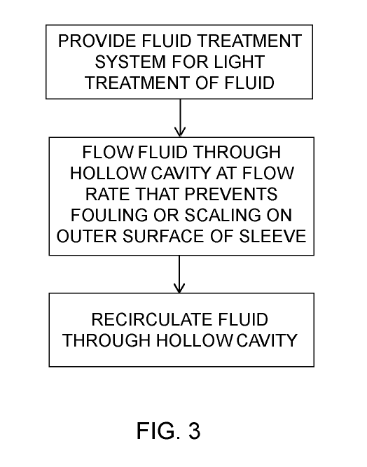

The method will now be described with references to the schematic flow diagram shown in FIG. 3.

The method comprises the steps of:
providing a fluid treatment system for light treatment of a fluid;
flowing said fluid into the cell by a fluid flowing device, through the hollow cavity at a velocity or 3 meter per second or more such that the velocity of the fluid in relation to the outer surface prevents fouling and/or scaling from aggregating on the outer surface of the sleeve;
recirculating said fluid through said hollow cavity by a recirculation assembly.

Furthermore, the method preferably includes the fluid flowing device to continuously flow the fluid into the cell, through the hollow cavity at a velocity, and out of the cell, and that the velocity is 3 meter per second or more. Different aspects of the velocity is discussed above.

According to one embodiment the method includes that the fluid flowing device 22 is configured to flow the fluid at a varying velocity. The velocity may then be varied between a low velocity limit, e.g. in the range of 3-5 m/s, and a high velocity limit, e.g. in the range of 6-8 m/s. This feature may be applicable in specific conditions that require higher cleaning capabilities.

In one alternative the method includes controlling the fluid flowing device to flow the fluid according to a predetermined velocity regimen, which velocity regimen includes control instructions for varying the velocity between a low velocity limit and a high velocity limit. Examples of the low velocity limit, the high velocity limit, and also of the velocity variation frequency are given above in connection with the description of the treatment system.

In another alternative the method includes controlling the fluid flowing device to flow the fluid according to a predetermined velocity regimen, which velocity regimen includes control instructions for repetitively temporarily increasing the velocity from a normal velocity to a predetermined high velocity. For numerical examples it is referred to the above description of the treatment system.

The present invention is not limited to the above-described preferred embodiments. Various alternatives, modifications and equivalents may be used. Therefore, the above embodiments should not be taken as limiting the scope of the invention, which is defined by the appending claims.

1. A fluid treatment system for treating a fluid, the system comprises:
a translucent sleeve-surrounding at least one light source and mounted within a cell of the system;
a housing configured to receive the sleeve therein, a hollow cavity is defined between an outer surface of the sleeve and an inner surface of the housing defining a cavity for flowing the fluid therein; wherein system comprises:
a fluid flowing device to flow said fluid through the hollow cavity at a velocity of 3 meter per second or more such that the velocity of the fluid in relation to the outer surface prevents fouling and/or scaling from aggregating on the outer surface of the sleeve,
a recirculation assembly configured to recirculate said fluid through said hollow cavity.

2. The fluid treatment system according to claim 1, wherein said fluid flowing device is configured to continuously flow said fluid into the cell, through the hollow cavity at a velocity, and out of the cell.

3. The fluid treatment system according to claim 1, wherein said fluid flowing device is a pump.

4. The fluid treatment system according to claim 1, wherein said defined hollow cavity is an annulus.

5. The fluid treatment system according to claim 1, wherein said recirculation assembly is a closed recirculation assembly.

6. The fluid treatment system according to claim 1, wherein said fluid flowing device is configured to flow the fluid at a varying velocity.

7. The fluid treatment system according to claim 1, wherein said fluid is an opaque fluid.

8. The fluid treatment system according to claim 1, wherein said fluid is an edible liquid or a metal working fluid.

9. A method for treating a fluid in a fluid treatment system that comprises:
a translucent sleeve surrounding at least one light source and mounted within a cell of the system;
a housing configured to receive the sleeve therein, a hollow cavity is defined between an outer surface of the sleeve and an inner surface of the housing defining a cavity for flowing the fluid therein;
wherein method comprises the steps of:
flowing said fluid into the cell by a fluid flowing device, through the hollow cavity at a velocity of 3 meter per second or more such that the velocity of the fluid in relation to the outer surface prevents fouling and/or scaling from aggregating on the outer surface of the sleeve;
recirculating said fluid through said hollow cavity by a recirculation assembly.

10. The method according to claim 9, wherein the method includes continuously flowing said fluid into the cell, through the hollow cavity at a velocity, and out of the cell.

11. The method according to claim 9, wherein the method includes flowing the fluid at a varying velocity.
